(19) United States
(12) Patent Application Publication
(10) Pub. No.: US 2025/0258317 A1
(43) Pub. Date: Aug. 14, 2025

(54) METHOD FOR MODELING CONTAINER INTERNAL WEATHER FROM METEOROLOGICAL DATA

(71) Applicant: HITACHI, Ltd., Tokyo (JP)

(72) Inventors: Chi Heem WONG, Santa Clara, CA (US); Misaki MITO, San Jose, CA (US); Arnab CHAKRABARTI, Milpitas, CA (US)

(21) Appl. No.: 19/193,778

(22) Filed: Apr. 29, 2025

Related U.S. Application Data
(63) Continuation-in-part of application No. PCT/US2023/033851, filed on Sep. 27, 2023.

(51) Int. Cl. G01W 1/02

(52) U.S. Cl. CPC G01W 1/02

(57) ABSTRACT

A method for estimating status of a container. The method comprising obtaining, by a processor, shipping information of the container; extracting, by the processor, weather information received from one or more databases from one or more locations corresponding to a location and time interval of the shipping information of the container; executing, by the processor, pre-processing on the weather information for an input to a feature generator to output intermediate features; and using, by the processor, the intermediate features to predict container temperature and container relative humidity, wherein the weather information is periodically resampled in response to updates to the shipping information of the container.

### CROSS REFERENCE TO RELATED APPLICATIONS

The present application is a bypass continuation-in-part of PCT Application No. PCT/US2023/033581, filed on Sep. 27, 2023, the contents of which are herein incorporated by reference in their entirety for all purposes.

### BACKGROUND

### Field

The present disclosure is generally directed to a method and a system for performing container status estimation.

### Related Art

Global trade largely relies on shipping containers, which have been standardized to save time and resources. However, the shipping containers themselves are opaque and difficult to monitor, and the resulting lack of visibility into cargo condition causes damage and waste. This in turn results in economic loss, delay, and exposure to various environmental and legal risks. In recent decades, an increasing number of shipments have been monitored by Internet-of-things (IoT) sensors that provide partial visibility into shipments by recording information such as the cargo location or the physical condition. A “sensorless” solution to monitor containers, such as using external weather data to estimate a container's internal weather, can complement, and in some cases, replace sensor measurements. It can be particularly useful when the shipping container does not have sensors, when the sensor fails, or when one wants to plan and prepare a future shipment.

The value of having visibility into a cargo in transit is widely acknowledged. In the related art, a method for estimating sensor data inside a container using measured sensor data outside a container through multi-regression equations is disclosed. The method estimates air temperature and dew-point temperature in containers to estimate probability of condensation. However, the method only provides for route specific humidity and temperature estimations and does not take physics theory into consideration in performing sensor data estimation.

In the related art, a method for observing container environment using devices/sensors is disclosed. The sensors record may be used to monitor gyro, inertia, humidity, temperature, light, strain, etc., and confidence levels may be determined to see if items were properly managed (e.g., no damage, spoilage, theft, etc.). While the sensors are capable of monitoring inside conditions of containers, installation of sensors in containers can be expensive and unfeasible. Furthermore, sensors often fail during transit, which leads to the loss of timely insights.

In the related art, an experimental method of estimating internal climate conditions using linear models is disclosed. Different sets of linear models are created for data points from summer, autumn and winter, and then approximated each route segment with a “season.” The method assumes that the world map can be divided into a finite number of distinct climate regions and that grounded container experiments can be conducted for each of these locations over a long period of time. These assumptions however, do not take weather conditions (e.g., rain, storm, etc.) into account in analysis performance and would lead to poor performance generalization when deployed. In addition, the method is unable to extrapolate to new locations or weather conditions easily without sacrificing accuracy.

There exists a need for a sensorless solution that provides accurate and timely estimates/forecasts of internal conditions of containers as they travel across the globe under wildly different weather patterns.

### SUMMARY

Aspects of the present disclosure involve an innovative method for estimating status of a container. The method may include obtaining, by a processor, shipping information of the container; extracting, by the processor, weather information received from one or more databases from one or more locations corresponding to a location and time interval of the shipping information of the container; executing, by the processor, pre-processing on the weather information for an input to a feature generator to output intermediate features; and using, by the processor, the intermediate features to predict container temperature and container relative humidity, wherein the weather information is periodically resampled in response to updates to the shipping information of the container.

Aspects of the present disclosure involve an innovative non-transitory computer readable medium, storing instructions for estimating status of a container. The instructions may include obtaining, by a processor, shipping information of the container; extracting, by the processor, weather information received from one or more databases from one or more locations corresponding to a location and time interval of the shipping information of the container; executing, by the processor, pre-processing on the weather information for an input to a feature generator to output intermediate features; and using, by the processor, the intermediate features to predict container temperature and container relative humidity, wherein the weather information is periodically resampled in response to updates to the shipping information of the container.

Aspects of the present disclosure involve an innovative server system for estimating status of a container. The server system may include obtaining, by a processor, shipping information of the container; extracting, by the processor, weather information received from one or more databases from one or more locations corresponding to a location and time interval of the shipping information of the container; executing, by the processor, pre-processing on the weather information for an input to a feature generator to output intermediate features; and using, by the processor, the intermediate features to predict container temperature and container relative humidity, wherein the weather information is periodically resampled in response to updates to the shipping information of the container.

Aspects of the present disclosure involve an innovative system for estimating status of a container. The system can include means for obtaining shipping information of the container; means for extracting weather information received from one or more databases from one or more locations corresponding to a location and time interval of the shipping information of the container; means for executing pre-processing on the weather information for an input to a feature generator to output intermediate features; and means for using the intermediate features to predict container temperature and container relative humidity, wherein the weather information is periodically resampled in response to updates to the shipping information of the container.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example diagram of a relative humidity prediction system 100, in accordance with an example implementation.

FIG. 2 illustrates an example data set of the cleansed data 102, in accordance with an example implementation.

FIG. 3 illustrates an example process flow 300 of the relative humidity prediction system 100, in accordance with an example implementation.

FIG. 4 illustrates error rates of the different temperature models across different training (in-sample) and test (hold-out) sets.

FIG. 5 illustrate error rates of the different relative humidity models across different training (in-sample) and test (hold-out) sets.

FIG. 6 illustrates a plurality of physical systems that are networked to a management apparatus, in accordance with an example implementation.

FIG. 7 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations provide sensorless method and system for performing container status estimation. The method and system utilize model building to obtain a shipping container's internal weather parameters (e.g., temperature and relative humidity) from external weather data with high accuracy/low error. Kernel regressions can be applied to new locations by interpolating the past weather patterns at various locations. In addition, scientific knowledge about the physical and thermodynamic properties of liquid-vapor mixtures is incorporated to better predict the weather conditions in the containers. Example implementations generalize the correlation between local weather conditions and containers' internal weather condition to make predictions on internal humidity.

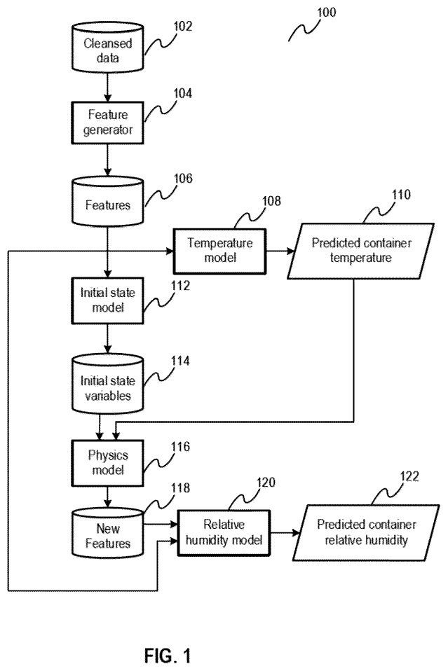

FIG. 1 illustrates an example diagram of a relative humidity prediction system 100, in accordance with an example implementation. The relative humidity prediction system 100 models sealed container as an ideal closed system between the time when the doors are closed at the point of origin and when the doors are opened at the destination. The relative humidity prediction system 100 generate predictions of internal weather conditions in containers by first receiving cleansed data 102. The cleansed data 102 may include data such as, but not limited to, preprocessed sensor data, preprocessed weather data, and other preprocessed variables that may impact containers' internal conditions (e.g., container type, cargo type, etc.). Data cleaning/preprocessing may involve at least one of data standardization, data normalization, data deduplication, outlier removal, data validation, etc.

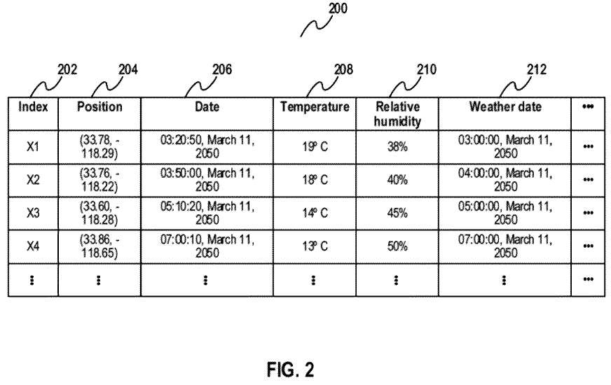

FIG. 2 illustrates an example data set of the cleansed data 102, in accordance with an example implementation. The example data set may include fields such as index 202, position 204, date 206, temperature 208, relative humidity 210, and weather date 212. The position 204, date 206, temperature 208, relative humidity 210, and weather date 212 are exogeneous variables that have relevance to containers' conditions. The index 202 denotes data identifiers associated with tracked data entries. The position 204 denotes location information associated with an entry. In some example implementations, the location information is obtained through global positioning systems (GPS) and expressed in latitude and longitude coordinates.

The date 206 denotes time and date information associated with a tracked entry. The temperature 208 denotes temperature at the time specified by the date 206 at position 204, and is also known as external temperature. The relative humidity 210 denotes humidity level at the time specified by the date 206 at position 204. The weather date 212 denotes last tracked weather time/date associated with an entry, and may include additional information such as weather condition at the specified time/date.

Referring back to FIG. 1, the cleansed data 102 is then used as input to a feature generator 104 to generate intermediate features 106. The intermediate features 106 may include same information as those contained in the cleansed data 102 (e.g., obtained through performance of identity mapping, etc.) or information derived through transformation of the cleansed data 102 (e.g., square, product, square root of, etc.). Example transformations of the cleansed data 102 may include square of solar radiation, product of wind speed and temperature, water vapor pressure, etc. Example intermediate features 106 obtained through identity mapping may include external temperature, etc. The intermediate features 106 may contain temporally aligned information and/or information generated at predetermined intervals.

The generated intermediate features 106 are then used as inputs to a temperature model 108 to generate predicted container temperature 110, to an initial state model 112 to generate initial state variables 114, and to a relative humidity model 120 to generate predicted container relative humidity 122. The initial state model 112 and the relative humidity model 120 will be described in more detail below.

By using the intermediate features 106 as input, the temperature model 108 is able to predict temperature inside a container. In some example implementations, the temperature model 108 is a trained Machine Learning (ML) model that employs neural network such as, but not limited to, Convolutional Neural Network (CNN), Recurrent Neural Network (RNN), etc., in generating the predicted container temperature 110. Historical container temperature data/information is used in training the temperature model 108.

The initial state model 112 generates one or more initial state variable 114 by using the intermediate features 106 as model input. The initial state model 112 transforms the intermediate features 106 using physics equations. Example initial state variables 114 may include, but not limited to, initial external wet-bulb temperature, initial external dry-bulb temperature, initial specific humidity, initial vapor pressure, initial relative humidity, initial dew-point temperature, initial degree of saturation, etc.

As an example, the initial specific humidity (the weight of water vapor per unit weight of dry air of the air inside the container when container doors are closed) can be derived through application of a number methods at the initial state model 112. For instance, psychrometric charts may be utilized in deriving initial specific humidity using variables such as dry-bulb temperatures and the relative humidity. The variables may be obtained through direct sensor measurements, approximated using weather data, etc.

The one or more initial state variable 114 and the predicted container temperature 110 then serve as inputs to a physics model 116 in deriving new features 118. The new features 118 are generated to help enhance the performance of the relative humidity model 120. The use of psychrometry, by way of example, is a specific instance of the physics model 116 used to derive new features 118 for use in the prediction of the internal climate conditions of containers without the use of sensors. Psychrometry is the science of measuring the water-vapor content of the air, and can be used to produce estimates of the relative humidity of the air under various conditions.

As an example, using the initial specific humidity and other point-in-time measurements of the thermodynamic property (e.g., temperature) in the container, the point-in-time relative humidity in the container can be estimated using the psychrometric charts, which in turn generates the new feature 118 of psychrometric relative humidity.

Taking the intermediate features 106 and the new features 118 as inputs, the relative humidity model 120 performs humidity prediction to generate relative humidity of the container, also known as predicted container relative humidity 122. In some example implementations, the relative humidity model 120 is a trained ML model that employs a neural network such as, but not limited to, Convolutional Neural Network (CNN), Recurrent Neural Network (RNN), etc., in generating the predicted container relative humidity 122. Historical intermediate feature and past features derived from the physics model 116 can be used in training the relative humidity model 120.

A number of steps are taken during the training phase of the relative humidity model 120. For a parametric model, the correct parameters and hyperparameters are generated during the training phase. For a non-parametric model, optimal hyperparameter selection may be optional. Both hyperparameter and parameter tuning are considered as “model training.”

In general, the relative humidity model 120 may be a parametric or a non-parametric model. A parametric model (Mₚ) hypothesizes the relationship between cleansed external data (X), the psychrometric features (ρ), and the containers' internal climate conditions given some hyperparameters (H) as:

Y=Mₚ(X, ρ; H)

Hyperparameters may not exist in some models.

By estimating Mₚ in the training phase from the set of training features (X_{T}, ρ_{T}), this results in the creation of a model \hat{M} that approximates M:

[symbol]

←training(X_{T}, ρ_{T})

In some example implementations, the hyperparameters of parametric models may be tuned. For example, in a neural network, the dropout rate is a hyperparameter and can be tuned by training the model iteratively with different dropout rates and selecting the one that provides the best performance. Tuning as part of the training phase even if the hyperparameter is explicitly set to a constant value or not used in the prediction phase.

During deployment, the trained parametric model \hat{M}ₚ acts on external features, \tilde{X}, and inputs from physics model(s) \tilde{ρ}, at the container's location to calculate Ŷ, which is an estimate of the container's internal parameters:

\hat{Y}= [symbol] (\tilde{X}, \tilde{ρ})

A simple parametric model is an ordinary least square regression, where the model is expressed as:

$$( \tilde{X} , \tilde{ρ} ) = α + \tilde{X} \vec{β} + γ \tilde{ρ}$$

where, α, β, γ are parameters or vector of parameters to be learned. The parameters can be estimated through gradient methods or matrix algebra.

Non-parametric models, on the other hand, do not have trainable parameters and rely instead on the training data set for estimation. The training data may be transformed or manipulated before being used for estimation. A non-parametric model (M_{NP}) attempts to predict a container's internal climate at a point in time by considering its set of external features (\tilde{X}) and psychrometric features (\tilde{ρ}), ground truth from the training data set (Y_{T}), the external features of the training data (X_{T}), and psychrometric features (ρ_{T}) of the training data given a set of hyperparameters (H):

Ŷ=M_{NP}(\tilde{X}, \tilde{ρ}, X_{T}, Y_{T}, ρ_{T}; H)

For the Nadaraya-Watson kernel regression, the model can be expressed as:

$${M}_{NP} ( \tilde{X} , \tilde{ρ} , {X}_{T} , {ρ}_{T} ; H ) = E [ Y \vert \tilde{X} , \tilde{ρ} , {X}_{T} , {ρ}_{T} ; H ] = {\sum }_{i ∈ {I}_{T}} \frac{{y}_{i} \cdot K ( \tilde{X} , {x}_{i} )}{{\sum }_{x ∈ {X}_{T}} K ( \tilde{X} , x )}$$

where [symbol] _{T} is the index of the data point in the training set and K(\tilde{X}, xᵢ) is the kernel. A common choice of kernel is the Gaussian kernel, which is defined as:

$$K ( \tilde{X} , {x}_{i} ) = {e}^{- \frac{{( \tilde{X} - {x}_{i} )}^{2}}{2 {σ}^{2}}}$$

In the above equation, σ is known as the kernel bandwidth. It can be set to a constant or estimated using methods such as least-squares cross-validation.

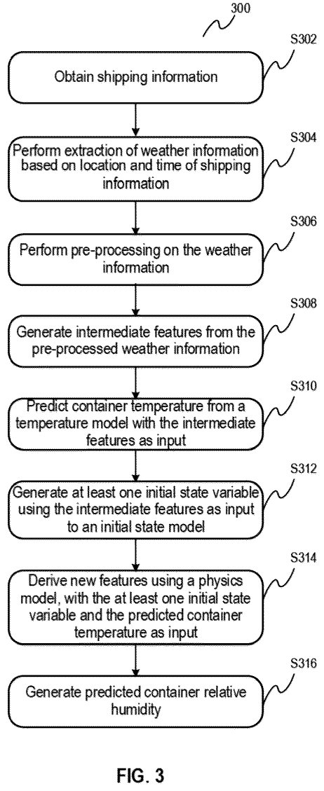

FIG. 3 illustrates an example process flow 300 of the relative humidity prediction system 100, in accordance with an example implementation. The process flow 300 begins at step S302 where shipping information of the container is obtained. At step S304, extraction of weather information received from one or more databases from one or more locations corresponding to a location and time interval of the shipping information of the container is performed. The weather information is periodically resampled in response to updates to the shipping information of the container.

The process then continues to step S306 where pre-processing on the weather information is performed. The pre-processed weather information is then used as input to a feature generator to output intermediate features at step S308. Then intermediate features are then fed into a temperature model to predict container temperature at step S310. At step S312, the intermediate features are used by an initial state model to generate at least one initial state variable.

Taking the at least one initial state variable and the predicted container temperature, new features are derived using physics model at step S314. The new features, along with the intermediate features are then taken as inputs to a relative humidity model to generate predicted container relative humidity at step S316.

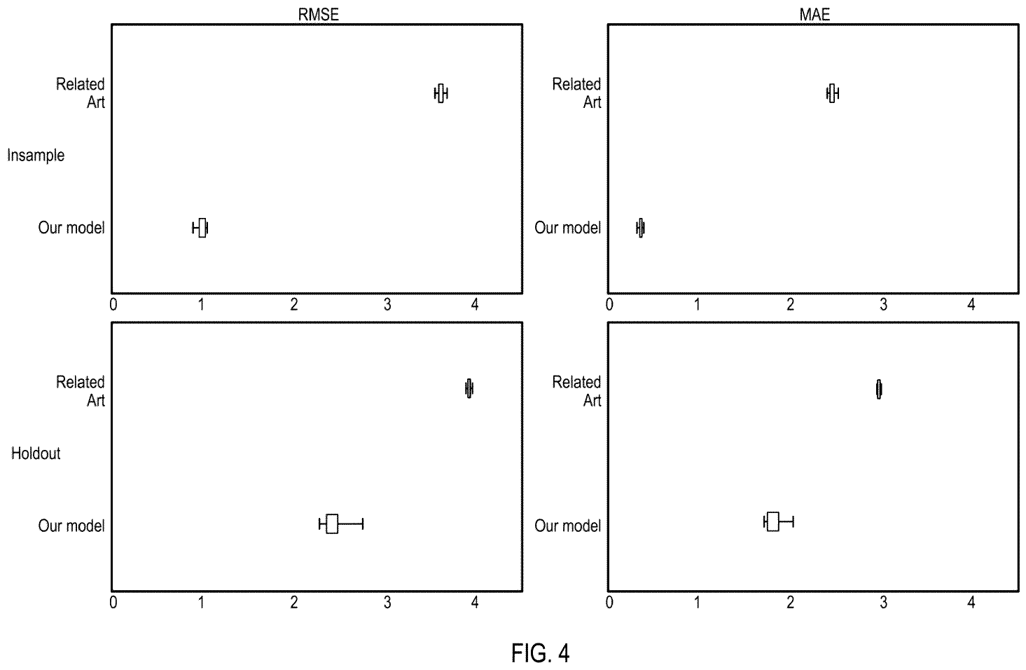

FIG. 4 illustrates error rates of the different temperature models across different training (in-sample) and test (hold-out) sets. RMSE and MAE denote “root mean squared error” and “mean absolute error,” respectively. As illustrated in FIG. 4, the error rates of the temperature model 108 are reduced by approximately two-fifths when compared against the related art.

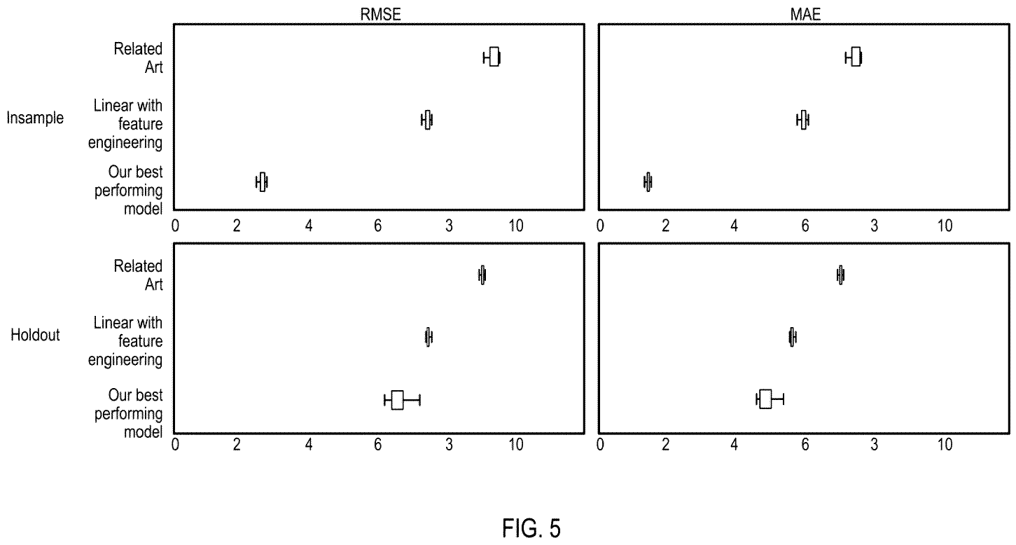

FIG. 5 illustrate error rates of the different relative humidity models across different training (in-sample) and test (hold-out) sets. As illustrated in FIG. 5, the error rates of the relative humidity model 120 are reduced by approximately one-third when compared against the related art. The use of psychrometry to engineer features leads to tangible benefits in the estimation of relative humidity.

The foregoing example implementation may have various benefits and advantages. For example, performing container status estimation without the need for container sensor placement. Various models are used to obtain a shipping container's internal weather parameters (e.g., temperature and relative humidity) from external weather data with high accuracy/low error. Sensorless monitoring allows for risk estimation and mitigation in situations where no measurements exist or data is scarce for a shipping route.

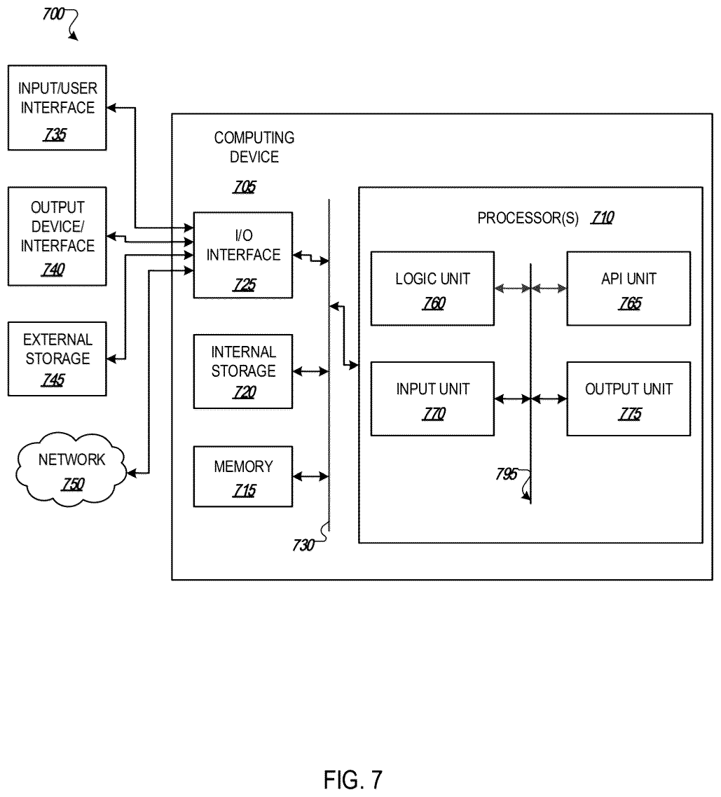

Example implementations described herein can also be applied to monitoring the inside of bulk shippers. Similar facilities and resources would be applied to such an example implementation. For example, one can replace ‘container’ with ‘bulk shipper hull’ in FIG. 1 and FIG. 3 and apply the process described in them to build a model for predicting the internal conditions of the bulk shipper hulk. One can then use the example computing environment described in FIG. 7 to make predictions of the internal environment of bulk shipper hulls.

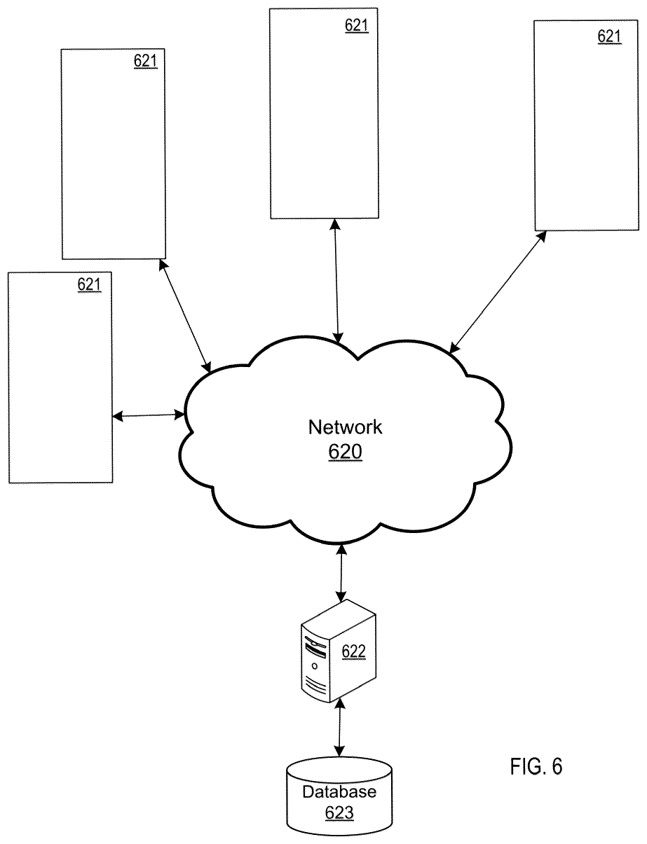

FIG. 6 illustrates a plurality of physical systems that are networked to a management apparatus, in accordance with an example implementation. One or more physical systems 621 (e.g., cargo boat, docketing port, truck, etc.) carrying one or more cargo loads are communicatively coupled to a network 620 (e.g., local area network (LAN), wide area network (WAN)) through the corresponding network interface of the sensor system installed in the physical systems 621, which is connected to a management apparatus 622. The one or more physical systems 621 may or may not be associated with sensors, depending on the desired implementation. The management apparatus 622 manages a database 623, which contains historical data collected from the sensor systems from each of the physical systems 621. In alternate example implementations, the data from the sensor systems of the physical systems 621 can be stored in a central repository or central database such as proprietary databases that intake data from the physical systems 621, or systems such as enterprise resource planning systems, and the management apparatus 622 can access or retrieve the data from the central repository or central database. The sensor systems of the physical systems 621 can include any type of sensors to facilitate the desired implementation, such as, but not limited to, gyroscopes, accelerometers, global positioning satellite, thermometers, humidity gauges, or any sensors that can measure one or more of temperature, humidity, gas levels (e.g., CO2 gas), and so on. As described herein, the management apparatus 622 can be configured to reach external servers to obtain pertinent weather data.

FIG. 7 illustrates an example computing environment with an example computer device suitable for use in some example implementations. Computer device 705 in computing environment 700 can include one or more processing units, cores, or processors 710, memory 715 (e.g., RAM, ROM, and/or the like), internal storage 720 (e.g., magnetic, optical, solid-state storage, and/or organic), and/or IO interface 725, any of which can be coupled on a communication mechanism or bus 730 for communicating information or embedded in the computer device 705. IO interface 725 is also configured to receive images from cameras or provide images to projectors or displays, depending on the desired implementation.

Computer device 705 can be communicatively coupled to input/user interface 735 and output device/interface 740. Either one or both of the input/user interface 735 and output device/interface 740 can be a wired or wireless interface and can be detachable. Input/user interface 735 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 740 may include a display, television, monitor, printer, speaker, braille, or the like. In some example implementations, input/user interface 735 and output device/interface 740 can be embedded with or physically coupled to the computer device 705. In other example implementations, other computer devices may function as or provide the functions of input/user interface 735 and output device/interface 740 for a computer device 705.

Examples of computer device 705 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 705 can be communicatively coupled (e.g., via IO interface 725) to external storage 745 and network 750 for communicating with any number of networked components, devices, and systems, including one or more computer devices of the same or different configuration. Computer device 705 or any connected computer device can be functioning as, providing services of, or referred to as a server, client, thin server, general machine, special-purpose machine, or another label.

IO interface 725 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 700. Network 750 can be any network or combination of networks (e.g., the Internet, local area network, wide area network, a telephonic network, a cellular network, satellite network, and the like).

Computer device 705 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 710 can execute under any operating system (OS) (not shown), in a native or virtual environment. One or more applications can be deployed that include logic unit 760, application programming interface (API) unit 765, input unit 770, output unit 775, and inter-unit communication mechanism 795 for the different units to communicate with each other, with the OS, and with other applications (not shown). The described units and elements can be varied in design, function, configuration, or implementation and are not limited to the descriptions provided. Processor(s) 710 can be in the form of hardware processors such as central processing units (CPUs) or in a combination of hardware and software units.

In some example implementations, when information or an execution instruction is received by API unit 765, it may be communicated to one or more other units (e.g., logic unit 760, input unit 770, output unit 775). In some instances, logic unit 760 may be configured to control the information flow among the units and direct the services provided by API unit 765, the input unit 770, the output unit 775, in some example implementations described above. For example, the flow of one or more processes or implementations may be controlled by logic unit 760 alone or in conjunction with API unit 765. The input unit 770 may be configured to obtain input for the calculations described in the example implementations, and the output unit 775 may be configured to provide an output based on the calculations described in example implementations.

Processor(s) 710 can be configured to obtain shipping information of the container as illustrated in FIG. 1. The processor(s) 710 may also be configured to extract weather information received from one or more databases from one or more locations corresponding to a location and time interval of the shipping information of the container as illustrated in FIG. 1. The processor(s) 710 may also be configured to execute pre-processing on the weather information for an input to a feature generator to output intermediate features as illustrated in FIG. 1. The processor(s) 710 may also be configured to use the intermediate features to predict container temperature and container relative humidity as illustrated in FIG. 1. The processor(s) 710 may also be configured to generate at least one initial state variable using the intermediate features as input to an initial state model as illustrated in FIG. 1. The processor(s) 710 may also be configured to generate new features using the at least one initial state variable and the predicted container temperature as inputs to a physics model as illustrated in FIG. 1.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to, optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for estimating status of a container, comprising:
obtaining, by a processor, shipping information of the container;
extracting, by the processor, weather information received from one or more databases from one or more locations corresponding to a location and time interval of the shipping information of the container;
executing, by the processor, pre-processing on the weather information for an input to a feature generator to output intermediate features; and
using, by the processor, the intermediate features to predict container temperature and container relative humidity,
wherein the weather information is periodically resampled in response to updates to the shipping information of the container.

2. The method of claim 1, wherein the weather information comprises external temperature data, external relative humidity data, and solar radiation data.

3. The method of claim 1,
wherein the intermediate features include at least one of pre-processed weather information or transformed pre-processed weather information, and the transformed pre-processed weather information comprises at least one of solar radiation, square of solar radiation, product of wind speed and temperature, or water vapor pressure.

4. The method of claim 1, the processor is configured to predict the container temperature by:
using the intermediate features as input to a first trained machine learning model to generate the container temperature,
wherein the first trained machine learning model is trained using historical container temperature data and historical weather information.

5. The method of claim 4, further comprising:
generating, by the processor, at least one initial state variable using the intermediate features as input to an initial state model.

6. The method of claim 5, wherein the at least one initial state variable comprises at least one of initial specific humidity, initial dew-point temperature, initial external wet-bulb temperature, initial external dry-bulb temperature, initial vapor pressure, initial relative humidity, or initial degree of saturation.

7. The method of claim 5, further comprising:
generating, by the processor, new features using the at least one initial state variable and the predicted container temperature as inputs to a physics model.

8. The method of claim 7, wherein the new features comprises psychrometric features.

9. The method of claim 7, the processor is configured to predict the container relative humidity by:
using the intermediate features and the new features as inputs to a second trained machine learning model to generate the container relative humidity.

10. The method of claim 9, wherein the container relative humidity is estimated point-in-time relative humidity inside the container.

11. A system for performing container status estimation, comprising:
a container; and
a processor, wherein the processor is configured to perform:
obtain shipping information of the container,
extracting weather information received from one or more databases from one or more locations corresponding to a location and time interval of the shipping information of the container,
execute pre-processing on the weather information for an input to a feature generator to output intermediate features, and
use the intermediate features to predict container temperature and container relative humidity,
wherein the weather information is periodically resampled in response to updates to the shipping information of the container.

12. The system of claim 11, wherein the weather information comprises external temperature data, external relative humidity data, and solar radiation data.

13. The system of claim 11,
wherein the intermediate features include at least one of pre-processed weather information or transformed pre-processed weather information, and the transformed pre-processed weather information comprises at least one of solar radiation, square of solar radiation, product of wind speed and temperature, or water vapor pressure.

14. The system of claim 11, the processor is configured to predict the container temperature by:
using the intermediate features as input to a first trained machine learning model to generate the container temperature,
wherein the first trained machine learning model is trained using historical container temperature data and historical weather information.

15. The system of claim 14, wherein the processor is further configured to:
generate at least one initial state variable using the intermediate features as input to an initial state model.

16. The system of claim 15, wherein the at least one initial state variable comprises at least one of initial specific humidity, initial dew-point temperature, initial external wet-bulb temperature, initial external dry-bulb temperature, initial vapor pressure, initial relative humidity, or initial degree of saturation.

17. The system of claim 15, wherein the processor is further configured to:
generate new features using the at least one initial state variable and the predicted container temperature as inputs to a physics model.

18. The system of claim 17, wherein the new features comprises psychrometric features.

19. The system of claim 17, the processor is configured to predict the container relative humidity by:
using the intermediate features and the new features as inputs to a second trained machine learning model to generate the container relative humidity.

20. The system of claim 19, wherein the container relative humidity is estimated point-in-time relative humidity inside the container.
